(19) United States
(12) Patent Application Publication
(10) Pub. No.: US 2014/0281160 A1
(43) Pub. Date: Sep. 18, 2014

(54) NON-VOLATILE SEMICONDUCTOR STORAGE APPARATUS

(71) Applicant: KABUSHIKI KAISHA TOSHIBA, Minato-ku (JP)

(72) Inventors: Riki Suzuki, Yokohama-shi (JP); Shohei Asami, Yokohama-shi (JP); Toshikatsu Hida, Yokohama-shi (JP); Hiroshi Yao, Yokohama-shi (JP); Kazuhiro Fukutomi, Yokohama-shi (JP)

(73) Assignee: KABUSHIKI KAISHA TOSHIBA, Minato-ku (JP)

(21) Appl. No.: 13/957,833

(22) Filed: Aug. 2, 2013

Related U.S. Application Data
(60) Provisional application No. 61/782,696, filed on Mar. 14, 2013.

(51) Int. Cl. G06F 12/02

(52) U.S. Cl. CPC G06F 12/0246
USPC 711/103

(57) ABSTRACT

According to one embodiment, apparatus includes non-volatile memory chips, and a first controller which executes processing for reading first valid data stored in a first storage region of a first non-volatile memory chip in the non-volatile memory chips, processing for storing the first valid data in a buffer memory, processing for writing the first valid data stored in the buffer memory in a second storage region of the first non-volatile memory chip, and processing for erasing data stored in the first storage region. Each of the non-volatile memory chips comprises erase blocks. Each erase block includes write blocks. Each of the first storage region and the second storage region includes at least one erase block.

### CROSS REFERENCE TO RELATED APPLICATIONS

This application claims the benefit of U.S. Provisional Application No. 61/782,696, filed Mar. 14, 2013, the entire contents of which are incorporated herein by reference.

### FIELD

Embodiments described herein relate generally to a non-volatile semiconductor storage apparatus.

### BACKGROUND

Nowadays, development of solid-state drives (SSD) which use NAND flash memories (hereinafter also simply referred to as a “flash memory”) that are rewritable non-volatile memories are being promoted.

Flash memories require data erase processing for a storage region, in which data is to be written, before writing is performed. In addition, a write unit (page) of flash memories is different from an erase unit (block) for erase processing thereof. A block is a storage region which corresponds to, for example, 64 pages.

In SSDs, when data rewriting for flash memories is proceeded, the rate of storage regions, which cannot store valid data, in the block increases since invalid data (data which are not newest) increases. SSDs perform compaction processing, to efficiently use storage regions in the block. The compaction processing is processing of collecting valid data items from a block, in which the density of the storage regions storing valid data has decreased, and rewriting the valid data items in another block. The block to be subjected to compaction is regenerated as a storage region which can be efficiently used, by erase processing performed after rewrite processing.

### BRIEF DESCRIPTION OF THE DRAWINGS

FIG. 1 is a block diagram illustrating an example of system configuration of an SSD according to an embodiment.

FIG. 2 is a diagram illustrating an example of assignment of logical blocks.

FIG. 3 is a diagram for explaining an example of compaction processing performed by a compaction controller.

FIG. 4 is a diagram for explaining an example of compaction processing performed by the compaction controller.

FIG. 5 is a diagram for explaining an example of compaction processing performed by the compaction controller.

FIG. 6 is a diagram for explaining an example of compaction processing performed by the compaction controller.

FIG. 7 is a diagram for explaining an example of data transfer between NAND flash memories in compaction processing.

FIG. 8 is a diagram for explaining an example of data transfer between the NAND flash memories in compaction processing.

FIG. 9 is a diagram for explaining an example of data transfer between the NAND flash memories in compaction processing.

FIG. 10 is a diagram for explaining an example of data transfer between the NAND flash memories in compaction processing.

FIG. 11 is a diagram for explaining an example of data transfer between the NAND flash memories in compaction processing.

FIG. 12 is a diagram for explaining an example of data transfer between the NAND flash memories in compaction processing.

FIG. 13 is a diagram for explaining an example of data transfer between the NAND flash memories in compaction processing.

FIG. 14 is a diagram illustrating an example of timings of reading and writing data from and to respective NAND flash memories.

FIG. 15 is a flowchart illustrating an example of process of the compaction processing.

FIG. 16 is a diagram for illustrating a noise cancelling operation according to a third embodiment.

FIG. 17 is a flowchart illustrating an example of process of leveling data sizes of logical blocks in the compaction destination.

FIG. 18 is a perspective view illustrating an example of a personal computer equipped with an SSD.

FIG. 19 is a bottom view illustrating an inside of a main body of the personal computer.

FIG. 20 is a block diagram illustrating system configuration of the personal computer equipped with the SSD.

FIG. 21 is a schematic diagram illustrating a server equipped with an SSD.

### DETAILED DESCRIPTION

In general, according to one embodiment, a non-volatile semiconductor storage apparatus comprises a plurality of non-volatile memory chips, a buffer memory, and a first controller. Each non-volatile memory chip includes a plurality of erase blocks. Each erase block includes a plurality of write blocks. The first controller is configured to execute processing to read first valid data stored in a first storage region of a first non-volatile memory chip in the non-volatile memory chips, processing to store the first valid data in the buffer memory, processing to write the first valid data stored in the buffer memory in a second storage region of the first non-volatile memory chip, and processing to erase data stored in the first storage region. The first storage region corresponds to a first management region. The second storage region corresponds to a second management region. Each of the first storage region and the second storage region includes at least one erase block.

Non-volatile semiconductor storage apparatuses according to embodiments will be explained in detail hereinafter with reference to drawings. The present invention is not limited by the embodiments.

### First Embodiment

FIG. 1 is a diagram illustrating configuration of a Solid State Drive (SSD) 1 serving as a non-volatile semiconductor storage apparatus which performs write processing and compaction processing in an embodiment. The SSD 1 comprises a host interface module 2, a data buffer 3, a controller 4, NAND controllers 50 to 53 (channel controlling modules), and NAND flash memories 100 to 115 (non-volatile memory chips). The controller 4 includes a write/read controller 41, a buffer controller 42, and a compaction controller 43.

NAND controllers 50 to 53 are connected with Channel 0 (Ch. 0) to Channel 3 (Ch. 3), respectively. Each channel is connected with NAND flash memories, which belong to different banks (for example, four banks consisting of Banks 0 to 3). For example, Channel 0 (Ch. 0) is connected with NAND flash memory 100 (NAND #0), NAND flash memory 104 (NAND #4), NAND flash memory 108 (NAND #8), and NAND flash memory 112 (NAND #12). The same is applicable to Channel 1 (Ch. 1) to Channel 3 (Ch. 3).

Bank 0 includes four NAND flash memories, that is, NAND flash memory 100 (NAND #0), NAND flash memory 101 (NAND #1), NAND flash memory 102 (NAND #2), and NAND flash memory 103 (NAND #3), which are connected to Channel 0 (Ch. 0) to Channel 3 (Ch. 3), respectively. The same is applicable to Banks 1 to 3. Although there are cases where each of NAND flash memories 100 to 115 corresponds to a NAND chip (non-volatile memory chip), theses are cases where NAND flash memories, which belong to adjacent banks connected to the same channel, form a NAND chip. For example, NAND flash memory 100 (NAND #0) and NAND flash memory 108 (NAND #7) form a NAND chip. Although the above example shows an example in which the number of channels is 4 and the number of banks per channel is 4, the number of channels and the number of banks are not limited to them.

In FIG. 4, when the SSD 1 receives a write command from a host device 10, the host interface module 2 checks free space in the data buffer 3, and transfers user data to the data buffer 3. NAND controllers 50 to 53 divide the user data received from the data buffer 3, and write the divided user data items in the respective channels and banks, in accordance with an instruction from the write/read controller 41.

The buffer controller 42 manages a logical address of the user data received from the host device 10 in correlation with an address on the data buffer 3 in which the user data is stored.

The write/read controller 41 instructs NAND controllers 50 to 53 to write the data on the data buffer 3 in NAND flash memories 100 to 115, when the quantity of user data which may be written to NAND flash memories 100 to 115 reaches a quantity which is convenient for the medium (NAND flash memories 100 to 115). The write-once algorithm is used as a write algorithm. Even when data is to be overwritten at the same logical address, the original data is not physically erased, but a new area is assigned to the new data, and correlation between the logical addresses and the physical addresses is updated.

When write processing is successively performed, regions which store invalid data increase on NAND flash memories 100 to 115. To avoid this problem, only valid data is collected and copied from a block which includes invalid data into another block. Data of the former block is erased, and the former block is subjected to processing to reuse the block to write new user data in. This processing is referred to as compaction (garbage collection) processing.

The compaction controller 43 executes compaction processing. The compaction controller 43 manages NAND flash memories 100 to 115 by using a plurality of logical blocks. The logical block is one of logical positional information items in the system. A unique MBA number is assigned to each logical block. Each logical block is formed of a plurality of physical blocks. Each logical block includes at least one erase block. Each erase block includes a write block.

FIG. 2 illustrates an example of assignment of logical blocks. As illustrated in FIG. 2, a logical block B0 is assigned to a storage region R00 of NAND flash memory 100 (NAND #0, C0), a storage region R10 of NAND flash memory 101 (NAND #1, C1), a storage region R20 of NAND flash memory 102 (NAND #2, C2), a storage region R30 of NAND flash memory 103 (NAND #3, C0), and a storage region R40 of NAND flash memory 104 (NAND #4, C4). The same is applicable to logical blocks B1 to B4.

The compaction controller 43 stores valid data, which is stored in a storage region of a NAND flash memory in a logical block, in a storage region of the same NAND flash memory in a different logical block.

When data is stored in an SSD, data is distributed and stored in a plurality of NAND flash memories which form the SSD. In such a case, while data 3 is written to a NAND flash memory which stores data 1 and data 2, data 1 or data 2 cannot be read from the NAND flash memory. Specifically, data 1, data 2, and data 3 depend on one another.

The data stored in a NAND flash memory, which includes data items depending on each other, cannot be read when any data is written to the NAND flash memory.

To remove dependence of data on each other, the compaction controller 43 stores data, which has been read from a specific chip, in a write buffer region, and writes the data stored in the write buffer region in a region of the same chip, to which data is transferred as a result of compaction.

In the following explanation, the compaction controller 403 is described as performing data reading and writing for NAND flash memories 100 to 115, although actually the write/read controller 41 performs data reading and writing for NAND flash memories 100 to 115 in accordance with instructions from the compaction controller 403. In addition, the compaction controller 403 is described as performing data reading and writing for the data buffer 3, although actually the buffer controller 42 performs data reading and writing for the data buffer 3 in accordance with instructions from the compaction controller 403.

Compaction processing performed by the compaction controller 43 will be explained hereinafter with reference to FIG. 3, FIG. 4, FIG. 5, and FIG. 6.

As illustrated in FIG. 3, the compaction controller 43 reads valid data stored in storage regions of logical blocks B0, B1, B2, and B3 of NAND flash memory 100 (C0), and stores the read valid data in a write buffer region 3A in the data buffer 3. The compaction controller 43 stores the valid data, which is stored in the write buffer region 3A, in logical block B4 of NAND flash memory 100 (C0). After the data is stored, compaction controller 43 erases the data stored in the write buffer region 3A and the storage regions of logical blocks B0, B1, B2, and B3 of NAND flash memory 100 (C0)

Next, as illustrated in FIG. 4, the compaction controller 43 reads valid data stored in storage regions of logical blocks B0, B1, B2, and B3 of NAND flash memory 101 (C1), and stores the read valid data in the write buffer region 3A in the data buffer 3. The compaction controller 43 stores the valid data, which is stored in the write buffer region 3A, in logical block B4 of NAND flash memory 101 (C1). After the data is stored, compaction controller 43 erases the data stored in the write buffer region 3A and the storage regions of logical blocks B0, B1, B2, and B3 of NAND flash memory 101 (C1). Erasing the data stored in the storage regions of logical blocks B0, B1, B2, and B3 means performing erasing for logical blocks B0, B1, B2, and B3.

Next, as illustrated in FIG. 5, the compaction controller 43 reads valid data stored in storage regions of logical blocks B0, B1, B2, and B3 of NAND flash memory 102 (C2), and stores the read valid data in the write buffer region 3A. The compaction controller 43 stores the valid data, which is stored in the write buffer region 3A, in logical block B4 of NAND flash memory 102 (C2). After the data is stored, compaction controller 43 erases the data stored in the write buffer region 3A and the storage regions of logical blocks B0, B1, B2, and B3 of NAND flash memory 102 (C2).

Next, as illustrated in FIG. 6, the compaction controller 43 reads valid data stored in storage regions of logical blocks B0, B1, B2, and B3 of NAND flash memory 103 (C3), and stores the read valid data in the write buffer region 3A. The compaction controller 43 stores the valid data, which is stored in the write buffer region 3A, in logical block B4 of NAND flash memory 103 (C3). After the data is stored, compaction controller 43 erases the data stored in the write buffer region 3A and the storage regions of logical blocks B0, B1, B2, and B3 of NAND flash memory 103 (C3).

As described above, the compaction controller 43 performs compaction processing.

Next, data transfer between NAND flash memories in compaction processing will be explained hereinafter, with reference to FIG. 7, FIG. 8, FIG. 9, FIG. 10, FIG. 11, FIG. 12, and FIG. 13.

FIG. 7 is a diagram illustrating states of data in NAND flash memory 100 (C0), NAND flash memory 101 (C1), NAND flash memory 102 (C2), NAND flash memory 103 (C3), and NAND flash memory 104 (C4) before compaction processing is performed. Hatched rectangles in FIG. 7 indicate the sizes of the valid data items.

NAND flash memory 100 (C0), NAND flash memory 101 (C1), NAND flash memory 102 (C2), and NAND flash memory 103 (C3) are subjected to compaction processing. The valid data items are written to NAND flash memory 104 (C4).

As illustrated in FIG. 8, the compaction controller 43 stores valid data items, which are stored in the storage regions of logical blocks B0, B1, B2, and B3 of NAND flash memory 100 (C0), in logical block B4 of NAND flash memory 100 (C0). After the data items are stored, the compaction controller 43 erases the data stored in the storage regions of logical blocks B0, B1, B2, and B3 of NAND flash memory 100 (C0).

As illustrated in FIG. 9, the compaction controller 43 stores valid data items, which are stored in the storage regions of logical blocks B0, B1, B2, and B3 of NAND flash memory 101 (C1), in logical block B4 of NAND flash memory 101 (C1). After the data items are stored, the compaction controller 43 erases the data stored in the storage regions of logical blocks B0, B1, B2, and B3 of NAND flash memory 101 (C1).

As illustrated in FIG. 10, the compaction controller 43 stores valid data items, which are stored in the storage regions of logical blocks B0, B1, B2, and B3 of NAND flash memory 102 (C2), in logical block B4 of NAND flash memory 102 (C2). The total size of the valid data items stored in the storage regions of logical blocks B0, B1, B2, and B3 of NAND flash memory 102 (C2) is greater than the size of the storage region of logical block B4 of NAND flash memory 102 (C2). Thus, it is impossible to store all the valid data items stored in the storage regions of logical blocks B0, B1, B2, and B3 of NAND flash memory 102 (C2) in the storage region of logical block B4 of NAND flash memory 102 (C2). The compaction controller 43 stores the position of the data item which was not stored in the storage region of logical block B4 of NAND flash memory 102 (C2). In FIG. 10, dotted rectangles in logical blocks B0, B1, B2, and B3 of NAND flash memory 102 (C2) correspond to the valid data items which have been written to logical block B4 of NAND flash memory 102 (C2). A checked rectangle in logical block B3 of NAND flash memory 102 (C2) corresponds to a valid data item which has not been written to logical block B4 of NAND flash memory 102 (C2).

As illustrated in FIG. 11, the compaction controller 43 stores valid data items, which are stored in the storage regions of logical blocks B0, B1, B2, and B3 of NAND flash memory 103 (C3), in logical block B4 of NAND flash memory 103 (C3). The total size of the valid data items stored in the storage regions of logical blocks B0, B1, B2, and B3 of NAND flash memory 103 (C3) is greater than the size of the storage region of logical block B4 of NAND flash memory 103 (C3). Thus, it is impossible to store all the valid data items stored in the storage regions of logical blocks B0, B1, B2, and B3 of NAND flash memory 103 (C3) in the storage region of logical block B4 of NAND flash memory 103 (C3). The compaction controller 43 stores the positions of the data items which were not stored in the storage region of logical block B4 of NAND flash memory 103 (C3). In FIG. 11, dotted rectangles in logical blocks B0, B1, B2, and B3 of NAND flash memory 103 (C3) correspond to the valid data items which have been written to logical block B4 of NAND flash memory 103 (C3). Checked rectangles in logical blocks B2 and B3 of NAND flash memory 103 (C3) corresponds to valid data items which have not been written to logical block B4 of NAND flash memory 103 (C3).

As illustrated in FIG. 12, the compaction controller 43 stores the valid data item, which is stored in any of the storage regions of logical blocks B0, B1, B2, and B3 of NAND flash memory 102 (C2) and has not been written to logical block B4 of NAND flash memory 102 (C2), in logical block B4 of NAND flash memory 102 (C2). The compaction controller 43 erases the data stored in the storage regions of logical blocks B0, B1, B2, and B3 of NAND flash memory 102 (C2).

As illustrated in FIG. 13, the compaction controller 43 stores the valid data items, which are stored in any of the storage regions of logical blocks B0, B1, B2, and B3 of NAND flash memory 103 (C3) and have not been written to logical block B4 of NAND flash memory 103 (C3), in logical block B4 of NAND flash memory 103 (C3). The compaction controller 43 erases the data stored in the storage regions of logical blocks B0, B1, B2, and B3 of NAND flash memory 103 (C3).

The above method is two-stage data-copying method using small difference in quantity of read data between the NAND flash memories.

FIG. 14 is a diagram illustrating timings of reading and writing data from the respective NAND flash memories.

As illustrated in FIG. 14, as a first stage, to eliminate dependence of data on each other in compaction processing, data items read from logical blocks in a specific NAND flash memory are stored in the write buffer, and written to a logical block of the same NAND flash memory, which serves as a compaction destination. The NAND flash memories subjected to copy processing are successively switched. In the above method, all the NAND flash memories can be driven in parallel, and thus copying can be performed at high speed.

The data quantity may differ between the NAND flash memories serving as the compaction destinations, due to difference in number of valid data items between blocks or difference in valid data quantity between the NAND flash memories. Thus, as the second stage, data of the block which has a deviation is distributed among the NAND flash memories to level the data quantities of the NAND flash memories. Specifically, part of the data of the NAND flash memory that has a large quantity of data is copied into other NAND flash memories which have a small quantity of data.

FIG. 15 is a flowchart illustrating a process of the compaction processing.

First, the compaction controller 43 determines whether a storage region, which serves as a compaction destination, of the same NAND flash memory has any free space (Step B11). When the compaction controller 43 determines that the storage region has free space (Yes in Step B11), the compaction controller 43 performs copy processing between the storage regions of the same NAND flash memory (Step B12). Then, the compaction controller 43 changes the NAND flash memory subjected to copy processing for another NAND flash memory (Step B13). Thereafter, the compaction controller 43 successively executes the processing from Step B11. When the compaction controller 43 determines that the storage region has no free space (No in Step B11), the compaction controller 43 determines whether a storage region, which serves as a compaction destination, of a different NAND flash memory has any free space (Step B14). When the compaction controller 43 determines that the storage region has free space (Yes in Step B14), the compaction controller 43 executes copying between the storage regions of the different NAND flash memories (Step B15). When the compaction controller 43 determines that the storage region has no free space (No in Step B14), the compaction controller 43 ends the processing.

The data read from a specific chip is stored in the write buffer region to eliminate dependence of data on each other, and the data stored in the write buffer region is written to a storage region of the same chip serving as the compaction destination. Thereby, it is possible to suppress increase in size of the write buffer region. Although the present embodiment shows an example of writing the data to the same chip, the data may be written to the same bank.

### Second Embodiment

### Leveling the Difference

The following is explanation of the case of leveling the data sizes of the logical blocks of the compaction destination, when there is difference in size of valid data between the logical blocks of the compaction source.

As illustrated in FIG. 16, the size of valid data in Bank 1 of the compaction source is greater than the size of valid data in Bank 0 of the compaction source, the size of valid data in Bank 2 of the compaction source, and the size of valid data in Bank 3 of the compaction source. The compaction controller 43 distributes the valid data in Bank 1 among the other banks of a compaction destination, and removes difference in data quantity between the banks. Valid data may be transferred between NAND flash memories, instead of between banks.

FIG. 17 is a flowchart illustrating a process of leveling data sizes of logical blocks of the compaction destination. The following flow is performed each time valid data of a write unit is written to the banks.

The compaction controller 43 determines whether there is any valid data in the bank (Step B21). When the compaction controller 43 determines that there is valid data (Yes in Step B21), the compaction controller 43 performs copying of valid data between storage regions of the same bank (Step B22). Then, the compaction controller 43 changes the bank subjected to copying for another bank (Step B23). When the compaction controller 43 determines that there is no valid data (No in Step B21), the compaction controller 43 determines whether valid data is stored in a different bank in the same logical block (Step B24). When the compaction controller 43 determines that there is valid data (Yes in Step B24), the compaction controller 43 performs copy processing of the valid data between the different banks (Step B25). When the compaction controller 43 determines that there is no valid data (No in Step B24), the compaction controller 43 ends the processing.

### Third Embodiment

The third embodiment is an example of configuration of a host device 10. The host device 10 can be formed of a personal computer.

FIG. 18 is a perspective view illustrating an example of a personal computer 200 equipped with the SSD 1 of the above embodiment. The personal computer 200 (for example, a notebook computer) comprises a main body 201 and a display unit 202. The display unit 202 includes a display housing 203, and a display device 204 contained in the display housing 203.

The main body 201 includes a housing 205, a keyboard 206, a touchpad 207 serving as a pointing device, and a button 208 (touchpad button). FIG. 19 is a bottom view illustrating an inside of the main body 201. The housing 205 contains a main circuit board 209, an SSD 1, and a battery unit 210 and the like.

The SSD1 may be used in a state of being mounted inside the personal computer 200 as a replacement for a conventional HDD, or used as an additional device in a state of being connected to the interface of the personal computer 200.

FIG. 20 is a block diagram illustrating an example of system configuration of the personal computer 200 equipped with the SSD 1. The personal computer 200 includes a CPU 301, a north bridge 302, a main memory 303, a video controller 304, an audio controller 305, a south bridge 309, a BIOS-ROM 310, the SSD 1, an ODD (Optical Disk Device) unit 311, an embedded controller/keyboard controller IC (EC/KBC) 312, and a network controller 313.

The CPU 301 is a processor provided to control operation of the personal computer 200, and executes an operating system (OS) loaded from the SSD 1 into the main memory 303. In addition, when the ODD unit 301 enables execution of at least one of read processing and write processing for the inserted optical disk, the CPU 301 executes them. The CPU 301 also executes a system BIOS (Basic Input Output System) stored in the BIOS-ROM 310. The system BIOS is a program for controlling hardware in the personal computer 200.

The north bridge 302 is a bridge device which connects a local bus of the CPU 301 with the south bridge 309. The north bridge 302 also includes a memory controller which controls access to the main memory 303. The north bridge 302 also has a function of executing communication with the video controller 304 and the audio controller 305, through an AGP (Accelerated Graphics Port) bus.

The main memory 303 temporarily stores programs and data, and functions as work area of the CPU 301. The main memory 303 is formed of, for example, a RAM.

The video controller 304 is a video playback controller which controls the display unit 202 used as a display monitor of the personal computer 200. The audio controller 305 is an audio playback controller which controls a speaker 306 of the personal computer 200.

The south bridge 309 controls the devices on, for example, an LPC (Low Pin Count) bus, and the devices on, for example, a PCI (Peripheral Component Interconnect) bus 315. The south bridge 309 also controls the SSD 1, which is a storage device that stores various software and data, through an ATA interface. The personal computer 200 executes access to each sector of the SSD 1. A write command, a read command, and a cashe flash command are inputted to the SSD 1 through the ATA interface. The south bridge 309 also has a function of controlling access to the BIOS-ROM 310 and the ODD unit 311.

The EC/KBC 312 is a one-chip microcomputer obtained by integrating an embedded controller for electric power control and a keyboard controller for controlling the keyboard (KB) 206 and the touchpad 207. The EC/KBC 312 has a function of turning on and off the power of the personal computer 200, in response to user's operation of a power button. The network controller 313 is a communication device which executes communication with an external network such as the Internet.

The host device 10 can also be formed of a server which is connected to a network. FIG. 21 is a schematic diagram illustrating a server 400 equipped with the SSD 1.

The server 400 includes an SSD 1 for data storage inside. The server 400 is connected to a network 401 (for example, the Internet). In addition to the server 400, the network 401 is connected with a plurality of clients 402 (personal computers) which provide information and functions of the server 400.

The server 400 provides the clients 402 with files and data stored in the SSD 1, and its functions.

Although the above embodiments show an example of using the SSD including NAND flash memories as memory system, the embodiments are not limited to it. The embodiments are applicable to other storage devices, such as a memory card equipped with NAND flash memories.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A non-volatile semiconductor storage apparatus comprising:
a plurality of non-volatile memory chips, wherein each of the non-volatile memory chips comprises a plurality of erase blocks, and each erase block comprises a plurality of write blocks;
a buffer memory; and
a first controller configured to execute processing for reading first valid data stored in a first storage region of a first non-volatile memory chip in the non-volatile memory chips, processing for storing the first valid data in the buffer memory, processing for writing the first valid data stored in the buffer memory in a second storage region of the first non-volatile memory chip, and processing for erasing data stored in the first storage region, wherein the first storage region corresponds to a first management region, the second storage region corresponds to a second management region, and each of the first storage region and the second storage region includes at least one erase block.

2. The apparatus of claim 1, wherein
the first management region corresponds to a first logical block, and
the second management region corresponds to a second logical block.

3. The apparatus of claim 1, wherein
the first management region comprises a third storage region of a second non-volatile memory chip in the non-volatile memory chips, and
the second management region comprises a fourth storage region of the second non-volatile memory chip in the non-volatile memory chips.

4. The apparatus of claim 3, wherein
the first controller is configured to write the first valid data in the fourth storage region, when the first valid data becomes unable to be written to the second storage region.

5. The apparatus of claim 3, wherein
the first controller is configured to execute processing for reading second valid data stored in the third storage region, processing for storing the second valid data in the buffer memory, processing for writing the second valid data stored in the buffer memory in the fourth storage region, and processing for erasing data stored in the third storage region, and
the first controller is configured to level a size of the valid data in the second storage region, and a size of the valid data in the fourth storage region.

6. The apparatus of claim 1, further comprising:
a plurality of second controllers, wherein each of the second controllers is connected with some of the non-volatile memory chips,
wherein the chips connected to the respective second controllers are equal in number.

7. The apparatus of claim 1, further comprising:
a third controller configured to execute data write processing and read processing for the non-volatile memory chips, in accordance with an instruction from the first controller.

8. A non-volatile semiconductor storage apparatus comprising:
a plurality of non-volatile memory chips;
a buffer memory; and
a controller configured to execute processing for reading first valid data stored in a first storage region of a first non-volatile memory chip in the non-volatile memory chips, processing for storing the first valid data in the buffer memory, processing for writing the first valid data stored in the buffer memory in a second storage region of the first non-volatile memory chip, and processing for erasing data stored in the first storage region.

9. A non-volatile semiconductor storage apparatus comprising:
a plurality of non-volatile memory chips;
a buffer memory; and
a controller executing processing to read first valid data stored in a first storage region of a first region in the non-volatile memory chips, processing to store the first valid data in the buffer memory, processing to write the first valid data stored in the buffer memory in a second storage region of the first region, and processing to erase data stored in the first storage region, wherein the first storage region corresponds to a first management region, and the second storage region corresponds to a second management region.

10. The apparatus of claim 9, wherein
the first region corresponds to a first non-volatile memory chip in the non-volatile memory chips.

11. The apparatus of claim 9, wherein
the first region corresponds to a bank.

12. The apparatus of claim 9, wherein
the first management region corresponds to a first logical block, and
the second management region corresponds to a second logical block.
